(19) United States
(12) Patent Application Publication
(10) Pub. No.: US 2018/0286071 A1
(43) Pub. Date: Oct. 4, 2018

(54) DETERMINING ANTHROPOMETRIC MEASUREMENTS OF A NON-STATIONARY SUBJECT

(71) Applicant: Body Surface Translations Inc., Athens, GA (US)

(72) Inventor: Eugene J. Alexander, Las Vegas, NV (US)

(21) Appl. No.: 15/940,809

(22) Filed: Mar. 29, 2018

Related U.S. Application Data
(60) Provisional application No. 62/478,772, filed on Mar. 30, 2017.

(51) Int. Cl. G06T 7/62; G06T 13/40; G06T 7/70; G01B 11/02

(52) U.S. Cl. CPC G06T 7/62; G06T 13/40; G06T 2207/20044; G01B 11/026; G06T 2207/10028; G06T 7/70

(57) ABSTRACT

Anthropometric measurements provide indicators of human and livestock health and wellbeing. Today, there is a well-developed manual protocol to measure the proportionate size of humans but it is slow, requires bulky and costly equipment, is subject to accuracy and precision errors, and requires initial and on-going training of field staff. There are also techniques to measure animal size but they generally require fixed installations and multiple imagers. Portable 3-D imaging systems in conjunction with portable computing devices and access to the cloud computing and storage infrastructure will be useful tools to automatically, objectively extract these anthropometric measures, and to consistently provide other anthropometric measures which heretofore have been unobtainable, provided the difficulty of scanning moving subjects can be overcome. The development of a system to automatically fit an articulated model to automatically generated 3-D point clouds is a novel approach to providing this critical developmental data.

### CROSS-REFERENCE TO RELATED APPLICATION

This application claims priority to and benefit of U.S. Provisional Patent Application No. 62/478,772 filed Mar. 30, 2017, which is fully incorporated by reference and made a part hereof.

### BACKGROUND

Anthropometric measurements provide indicators of child health and wellbeing. Today, there is a well-developed protocol to measure the proportionate size of the infant body but it is slow, requires bulky and costly equipment, is subject to accuracy and precision errors, and requires initial and on-going training of field staff. Similarly, anthropometric measurements can be used in livestock farming to ensure adequate nutrition and growth of the animals.

Anthropometric data are used for many purposes. For example, nationally-representative surveys include anthropometric indicators such as stunting, wasting and overweight, and this information is used to track progress over time, and inform policy and program development both nationally and globally. Anthropometric indices are used also to evaluate the impact of interventions to improve child health and nutrition and to allow comparisons of cost-effectiveness among interventions. Finally, anthropometric measurements have important clinical applications in evaluating patients with severe and chronic malnutrition and for monitoring child neurodevelopment. Poor measurement compromises all of these uses. Even extremely well-trained anthropometrists demonstrate a Total Error Measurement (TEM) that can overwhelm subtle effects of an intervention. Field trained personnel can be expected to have even higher TEM.

Therefore, what are needed are systems and methods that overcome challenges in the art, some of which are described above. The systems and methods described herein provide an automated alternative to manual approaches of anthropometric measurement that provides a fully automatic, objective measure of subject surface geometry and the automatic extraction and storage of anthropometric measure of interest.

### SUMMARY

Described and disclosed herein are embodiments of a robust, low-cost, easy to use, objective, automated system to extract anthropometric information from infants between the ages of 0-24 months as well as children 25-60 months using three-dimensional (3-D) imaging technology. The automated measurements have been validated against the current gold standard, physical measurements of infant head and arm circumference and body length/height. An advantage to the disclosed embodiments is that measurements can be obtained from test subjects that are not capable of standing still for a measurement, as opposed to older children and adults.

Disclosed and described herein are embodiments of a system, method and computer-program product for determining anthropometric measurements of a non-stationary subject. One embodiments comprises scanning a non-stationary subject using a three-dimensional (3-D) scanner to create a plurality (N) of point clouds of data corresponding to the subject. Once the plurality (N) of point clouds have been captured, a processor executing computer-executable instructions is used to perform the following steps:
(a) estimate a rough size of the subject using the point cloud of data;
(b) estimate a rough pose of the subject using the point cloud of data;
(c) change the estimated rough size and the estimated rough pose of the point cloud of data of the subject to best match a surface of a skinning weight articulated model; and
(d) repeat a.-c., above, for each of the plurality (N) of point clouds to create N skinning weight articulated models, wherein each skinning weight articulated model corresponds to one of the plurality of point clouds.

The N skinning weight articulated models are optimized by the processor executing computer-executable instructions to find one set of size parameters and N sets of fitted pose parameters that minimize the distance between the n^{th} point cloud data set and the n^{th} articulated model vertices for all N point clouds. The processor executing computer-executable instructions moves each of the N skinning weight articulated models to a neutral position from its fitted position, wherein the fitted position is based on the skinning weight articulated model's fitted pose parameters. The processor executing computer-executable instructions determines a transformation based on knowing the fitted and neutral position of each of the N skinning weight articulated models, applies the transformation to each of the plurality (N) of point clouds to produce a single merged point cloud in the neutral pose space, matches the merged point cloud in the neutral pose space to a final skinning weight articulated model in the neutral pose, and obtains anthropometric measurements from the final skinning weight articulated model in the neutral pose.

In one aspect, scanning the subject using the three-dimensional (3-D) scanner to create a plurality (N) of point clouds of data corresponding to the subject comprises scanning the subject using a 3-D hand scanner. The scanner may be used to capture bursts of data. For example, each burst of data may range from 0.10 to 0.50 seconds of scan data so that there is little to no movement of the subject while capturing the burst of data. By capturing bursts of data, three to 10 bursts of data may be captured during the scan of the subject. Each of the three to 10 bursts of data captured during the scan comprises one of the plurality (N) of point clouds of data corresponding to the subject. Each of the plurality (N) of point clouds of data corresponding to the subject comprises a pose of the subject.

In some aspects, each burst of data may be captured from 0.3 to 1.5 seconds.

Each burst of data to determine if it is rejected or accepted. In one aspect, after rejecting one or more bursts of data, the scan of the subject is rejected if the accepted bursts of data are three or less.

In one aspect, estimating the rough size of the subject using the point cloud of data comprises estimating the rough size of the subject based on an age of the subject. In some aspects, this may be performed using a lookup table. For example, the lookup table may be a table compiled by the World Health Organization (WHO).

In some aspects, estimating the rough pose of the subject using the point cloud of data comprises a search through a generated database of possible poses. The search through the generated database of possible poses may be performed using a sub-space search technique that uses principal component analysis.

In some aspects, changing the estimated rough size and the estimated rough pose of the point cloud of data of the subject to best match the surface of the skinning weight articulated model comprises using an adaptation of an iterated closest point algorithm for articulated models. The skinning weight articulated model may comprise a computer-generated hierarchical set of bones and joints to form a skeleton created by an animator and a computer-generated skin surface is attached to the skeleton by a weighting technique.

In some aspects, optimizing the N skinning weight articulated models to find one set of size parameters and N sets of fitted pose parameters comprises using a modified iterated closest point cloud algorithm, determining the one set of size parameters by adjusting a size parameter of each of the skinning weight articulated models to match all of the skinning weight articulated models to their corresponding point cloud data; and determining the N sets of fitted pose parameters by adjusting a pose parameter for each of the skinning weight articulated models to match the skinning weight articulated model to its corresponding point cloud.

Generally, obtaining anthropometric measurements from the final skinning weight articulated model in the neutral pose comprises measuring a distance along defined arcs on final skinning weight articulated model.

It is to be noted that the disclosed systems, methods and computer program product may be used to obtain anthropometric measurements of humans as well as non-humans such as swine and bovine, among other animals.

In some instances, cloud computing and storage infrastructure is used to perform some or all of the described processing and/or data storage and retrieval

It should be understood that the above-described subject matter may also be implemented as a computer-controlled apparatus, a computing system, or an article of manufacture, such as a computer-readable storage medium.

Other systems, methods, features and/or advantages will be or may become apparent to one with skill in the art upon examination of the following drawings and detailed description. It is intended that all such additional systems, methods, features and/or advantages be included within this description and be protected by the accompanying claims.

### BRIEF DESCRIPTION OF THE DRAWINGS

The components in the drawings are not necessarily to scale relative to each other. Like reference numerals designate corresponding parts throughout the several views.

FIG. 1 illustrates an exemplary overview system for performing anthropometric measurements;

FIG. 2 is a flowchart illustrating the operation of the exemplary system of FIG. 1;

FIGS. 3A and 3B illustrate an articulated model, specifically a skinned-mesh model showing the skeleton (3A) and the fitted “skin” (3B);

FIG. 4 is a flowchart illustrating an exemplary overall model fitting process;

FIGS. 5A, 5B and 5C illustrate decomposing a new data set to its principal component sub-space representation, where FIG. 5A illustrates and image of the data set 3-D point cloud projected on a plane; FIG. 5B illustrates the nearest fit in the image database according to the sub-space distance metric; and FIG. 5C illustrates the corresponding 3-D model, for initialization;

FIGS. 6A and 6B illustrate application of an adaptation of the Iterated Closest Point algorithm for articulated models that is used to change the size and pose of the model to best match the surface of the animator's model, where FIG. 6A shows the initialized model (red vertices 602, blue joints and bones 604) prior to the Articulated Model Iterated Closest Point algorithm and FIG. 6B shows the model after application of the algorithm;

FIGS. 7A-7F illustrate optimizing the N skinning weight articulated models to find one set of size parameters and N sets of fitted pose parameters that match the skinning weight articulated models to the 3-D point clouds, where FIGS. 7A-7B show six articulated models fitted to six 3-D point clouds, each model of the same size but with a different pose;

FIGS. 8A-8D show four perspective views of a posture neutral combined point cloud;

FIG. 9 is an illustration of obtaining an anthropometric measure of interest by measuring distance along defined arcs on the final skinning weight articulated model; and

FIG. 10 is a block diagram of an example computing device upon which embodiments of the invention may be implemented.

### DETAILED DESCRIPTION

Unless defined otherwise, all technical and scientific terms used herein have the same meaning as commonly understood by one of ordinary skill in the art. Methods and materials similar or equivalent to those described herein can be used in the practice or testing of the present disclosure.

As used in the specification and the appended claims, the singular forms “a,” “an” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other additives, components, integers or steps. “Exemplary” means “an example of” and is not intended to convey an indication of a preferred or ideal embodiment. “Such as” is not used in a restrictive sense, but for explanatory purposes.

Disclosed are components that can be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all aspects of this application including, but not limited to, steps in disclosed methods. Thus, if there are a variety of additional steps that can be performed it is understood that each of these additional steps can be performed with any specific embodiment or combination of embodiments of the disclosed methods.

The present methods and systems may be understood more readily by reference to the following detailed description of preferred embodiments and the Examples included therein and to the Figures and their previous and following description.

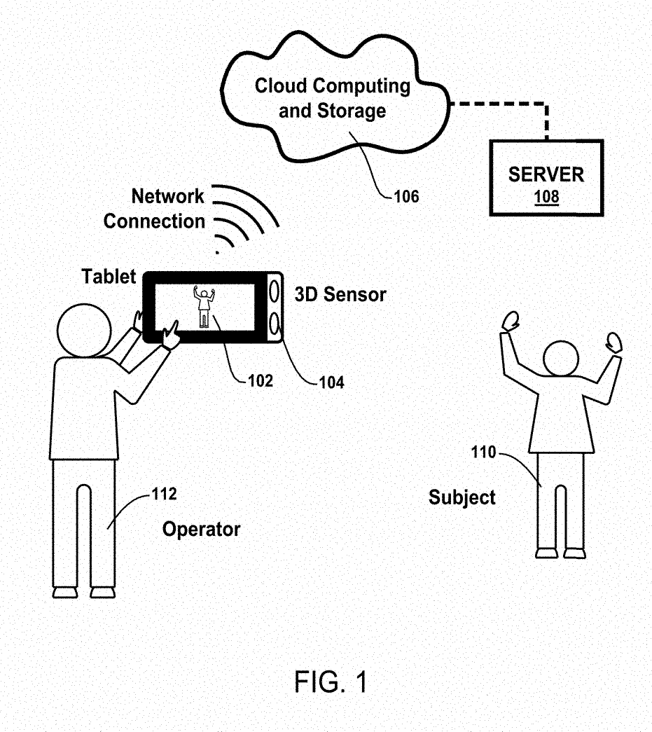

Referring now to FIG. 1, an exemplary overview system for performing anthropometric measurements is described. It should be understood that the disclosed anthropometric measurements can be at least partially performed by at least one processor (described below). Additionally, the anthropometric measurements can optionally at least be partially implemented within a cloud computing environment, for example, in order to decrease the time needed to perform the algorithms, which can facilitate visualization of the prior analysis on real-time images. Cloud computing is well-known in the art. Cloud computing enables network access to a shared pool of configurable computing resources (e.g., networks, servers, storage, applications, and services) that can be provisioned and released with minimal interaction. It promotes high availability, on-demand self-services, broad network access, resource pooling and rapid elasticity. It should be appreciated that the logical operations described herein with respect to the various figures may be implemented (1) as a sequence of computer implemented acts or program modules (i.e., software) running on a computing device, (2) as interconnected machine logic circuits or circuit modules (i.e., hardware) within the computing device and/or (3) a combination of software and hardware of the computing device. Thus, the logical operations discussed herein are not limited to any specific combination of hardware and software. The implementation is a matter of choice dependent on the performance and other requirements of the computing device. Accordingly, the logical operations described herein are referred to variously as operations, structural devices, acts, or modules. These operations, structural devices, acts and modules may be implemented in software, in firmware, in special purpose digital logic, and any combination thereof. It should also be appreciated that more or fewer operations may be performed than shown in the figures and described herein. These operations may also be performed in a different order than those described herein.

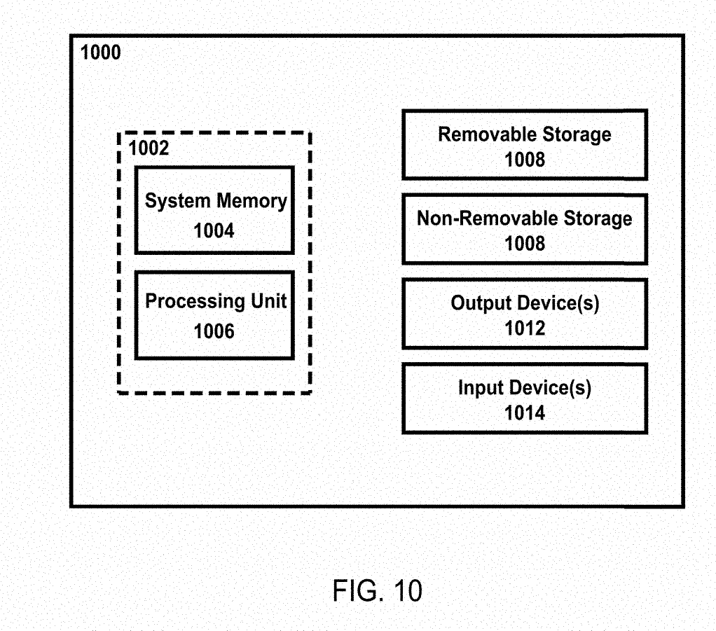

Referring now to FIG. 1, an exemplary embodiment of a system for anthropometric measurement comprises an acquisition device 102. The acquisition device further comprises (not shown in FIG. 1) a processor, a memory, data storage, and at least one network connection (see FIG. 10 for an exemplary acquisition device). In various aspects, the acquisition device may comprise a smart phone, a computing tablet, a laptop computer, and the like. Further comprising the exemplary system is a 3-D sensor system 104 capable of being connected to the acquisition device 102. As a non-limiting example, the 3-D sensor system 104 may comprise an Occipital Structure Sensor (Occipital, Inc., San Francisco, Calif.). Acquisition software for acquiring scans of a non-stationary subject resides on and is executed by the acquisition device 102. In one aspect, the acquisition software may perform at least a portion of the processing of the data acquired in the scans for performing the anthropometric measurements. As used herein, “subject” means human and non-human including animals such as swine, bovine, and the like.

Further comprising the exemplary system of FIG. 1 is a website and online database. In one aspect, the website and online database can be hosted in the cloud 106. For example, the website and online database may be hosted by a cloud service such as Amazon Web Services (Amazon Web Services, Inc., Seattle, Wash.). Anthropometric estimation software resides in the cloud infrastructure 106 or on a dedicated server 108 that can access the data stored in the cloud 106.

Referring back to FIG. 1, in operation the test subject 110 is positioned a distance (e.g., 2-6 feet) away from the operator 112 operating the acquisition device 102 and 3-D sensor 104. For a subject 110 capable of standing and responding to instructions, the subject 110 is oriented either directly facing the operator 112 or directly away from the operator 112. Generally such subjects are over two years of age. For subjects under two years of age or those that cannot stand and/or respond to instructions, the subject 110 is placed prone on a flat surface or supine on a flat surface. The acquisition software executing on the acquisition device 102 is adjusted so that the size of an acquisition volume associated with the subject 110 encompasses the subject 110 completely.

For younger test subjects that cannot in general respond appropriately to requests to stand still, the acquisition software executing on the acquisition device 102 is designed to capture multiple short bursts of point cloud data. Each burst of point cloud data is incorporated into the anthropometric estimation. Generally, such short scans that create the bursts of data range from 0.10 to 0.25 seconds of data acquisition, at approximately 30 frames of data per second, to create a single point cloud that includes data from each scan. The amount of acquisition time is determined by the operator 112 based on the ability of the subject 110 to stand still, with older children being acquired at the 0.25 second bursts and younger and uncooperative children at 0.10 second bursts. The trade-off is between a better point cloud (smoother and with a more complete surface) versus the artifacts induced by the subject movement. Capturing bursts of point cloud data accommodates capturing data from non-stationary subjects.

For each of the front and back poses of the subject 110, the acquisition software executing on the acquisition device 102 captures anywhere from three to ten bursts of data. Each burst of data is an imperfect point cloud representing one aspect of the subject's surface geometry. The result of a complete scan is six to twenty 3-D point clouds of the subject 110 from the front and the back.

The acquisition software executing on the acquisition device 102 automatically uploads all of the 3-D point cloud data for the subject into a database. In one aspect, this database may reside in the cloud 106. In addition to the point cloud data, the subject's 110 name, age, weight, and other demographic data elements of interest can be uploaded and stored automatically. In addition, in some embodiments the manual anthropometry of the subject is acquired and recorded onto the device. This manual anthropometric data may then also be automatically uploaded into the database.

The subject 110, while generally not moving much during a capture burst will likely have moved during the course of a scan sequence. Generally this is referred to as the subject 110 being in different poses. The anthropometric estimation software accommodates these noisy multiple point clouds of a subject in various poses; while the pose of the subject is different at these bursts, the size of the subject is the same.

Overall the anthropometric estimation process proceeds by fitting a generic articulated model of a human to the point cloud data of the subject 110 using the anthropometric estimation software. The anthropometric metrics of interest can then be directly extracted from the fitted model. The anthropometric estimation software is designed to estimate the articulated model of a human being that best fits the multiple point clouds given a single size model at multiple poses.

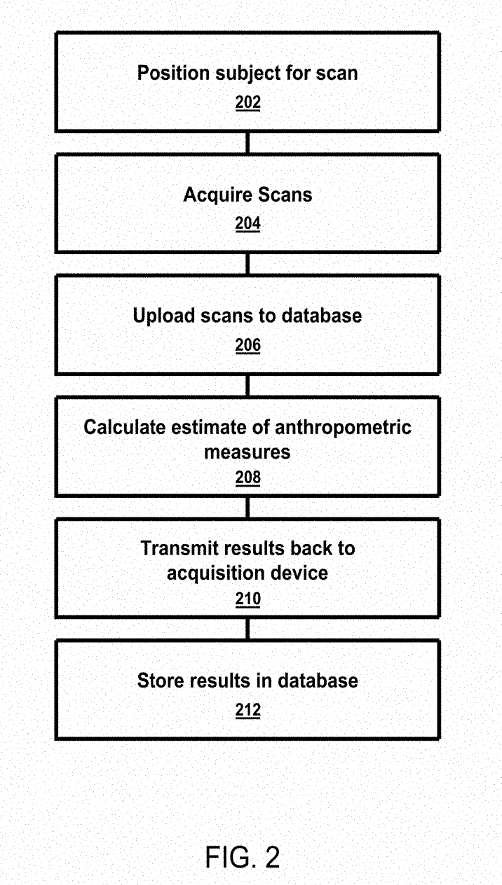

FIG. 2 is a flowchart illustrating the operation of the exemplary system of FIG. 1. At 202, a test subject 110 is positioned for one or more scans. At 204, an operator 112 takes the scans. Each of the scans creates point data of the subject 110. A single scan may create three-dimensional point clouds or a plurality of scans may be combined to form three-dimensional data. At 206, the point cloud data from the scans can be uploaded to a database. For example, the scan data may be automatically uploaded to a database residing in the cloud 106. At 208, anthropometric estimation software is run on the scan data. The software fits an articulated model of a human to the scan data that is comprised of 3-D point clouds to create a fitted model. Anthropometric data of interest is extracted from the fitted model, which is at 210 pushed back (transmitted) from the database to the acquisition device 102 and 212 stored in the database. As noted above, the database may reside in a cloud infrastructure 106 and the anthropometric data of interest extracted from the fitted model may be transmitted wirelessly from the cloud infrastructure 106 to the acquisition device 102.

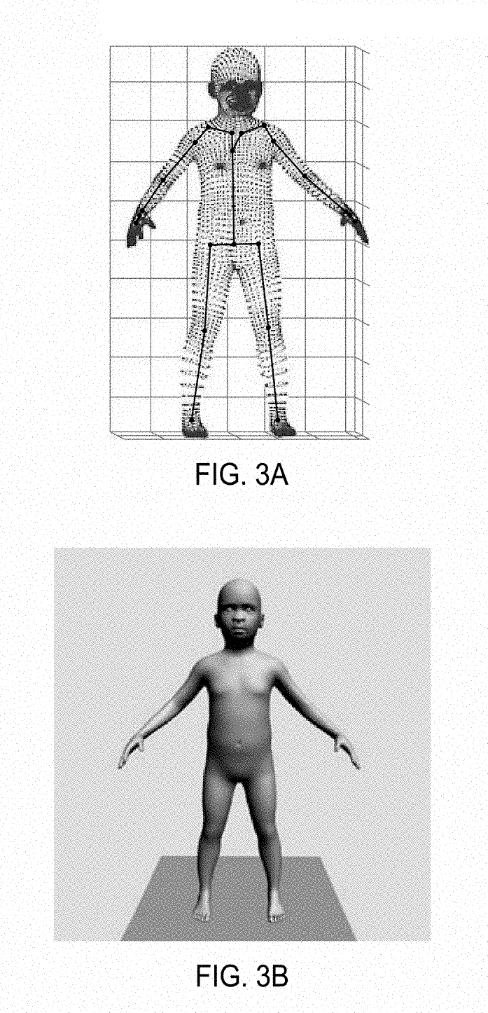

FIGS. 3A and 3B illustrate an articulated model, specifically a skinned-mesh model showing the skeleton (3A) and the fitted “skin” (3B). It allows a non-rigid geometric element such as a human or an animal or a mythical creature to be created once by a skilled artist, and then posed in in various ways, either by an animator (in animation) or by procedural methods (gaming). In general, a skinned-mesh model has “bones”, “joints”, “skin”. The skin is composed of vertices of a mesh, which covers the exterior of the model. The vertices are tied to one or more bones by a weighting—a vertex that move in complete lock-step with a bone would only have a single weight, of 1.0 associated with that bone. Such a vertex might be mid-thigh. A vertex closer to the knee might have two weights, one associated with the thigh bone and one associated with the shin bone, in order to have the vertex move smoothly as the knee is flexed. The joints are where the bones meet, and after the creation by a modeler are the only elements of the model changed by animator or software. As the animated model “moves”, the joints are rotated, which in turn move the associated bones, which in turn move the vertices associated with those bones. Mathematically

$$outv = {\sum }_{b = 0}^{n} \{ ( ( v * BSM ) * IBMi * JMi ) * JW \}$$

where outs is the output vertex location in the world coordinate system; BSM is a bind-shape matrix; IBMi: is an inverse bind-pose matrix of joint I; JMi: is a transformation matrix of joint i; JW is a weight of the influence of joint i on vertex v; n is the number of bones to which this vertex is weighted; and v is the location of the vertex in world system at model creation.

v, BSM, IBMi, and JW are constants with regards to some skeletal animation. In practice, as the model is moved in the animation or game, the joint transformation matrices are updated at each time step. This may be a parameter set of anywhere from 2 to 100 (or more, for very detailed facial animation). After the joints are updated, the output location of all vertices is calculated, which may be a surface mesh comprising hundreds or thousands or even tens of thousands of vertices.

While not useful in traditional animation or gaming settings, it is also possible to include a scaling matrix within the transformation matrix of the joints, in addition to rotations. That scaling matrix is included in the present implementation, in order to facilitate differential fitting of the articulated model to the set of 3D point clouds.

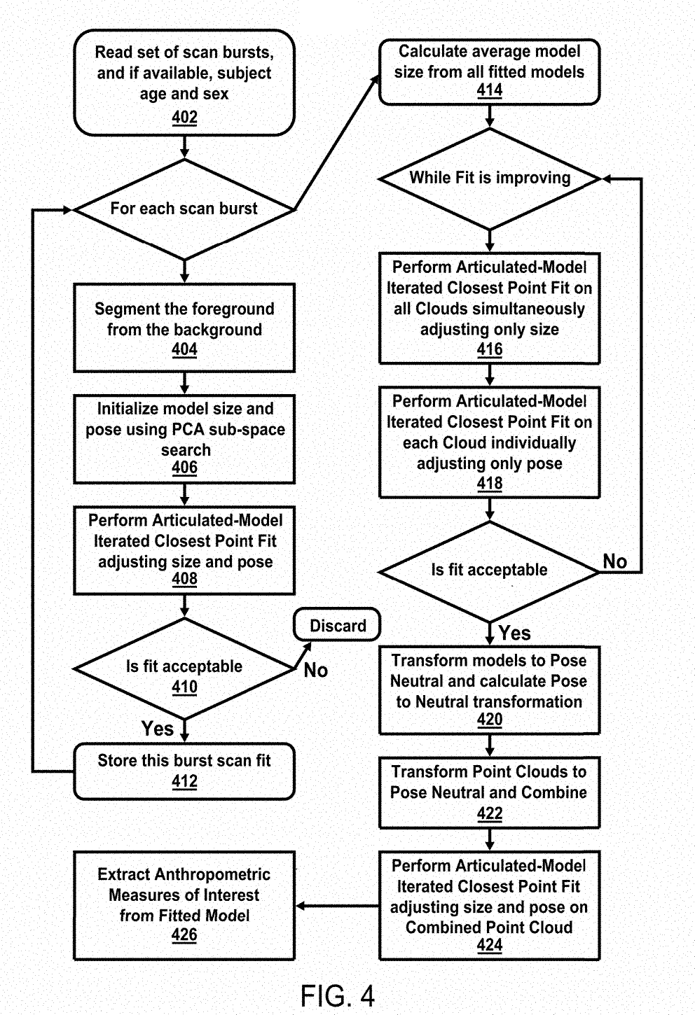

A flowchart illustrating an exemplary overall model fitting process is shown in FIG. 4. The uploading of the data (or on command by an operator) triggers the automatic operation of the anthropometric estimation software. That process begins with 402, reading of all of the point cloud data, along with any available demographic data provided in the child, in particular sex and age. These data fields will be used to initialize the size of the articulated model by referral to a lookup table. In one embodiment the lookup table comprises a table derived from World Health Organization (WHO) height-for-age averages.

The data process starts by operating on a single 3-D point cloud at a time. The first step 404 is foreground-background segmentation. The 3-D scan in general captures data on the test subject and potentially other items in the room—other people in the background, items in the background like chairs or walls etc. The anthropometric estimation software uses as a clue the location of the point cloud in the center of the image—that is assumed to be the subject. The depth of the subject relative to the imaging device is determined, and any 3-D point further away than some constant value is discarded. In addition, the central point of the remaining point cloud is taken as a seed, and any points not connected to the central point are discarded. This in practice produces a single point cloud representing the test subject.

The next step 406 is to initialize the model to this point cloud. The size is initialized by knowing the age of the subject, and using a look-up table provided by WHO to estimate the height of the subject. The pose is estimated through a search through a generated database of possible poses, using the well-known using principal component analysis sub-space search technique. The pose initialization process involves a number of steps. In a first step, prior to working on any new data, two databases of images (front and back) are created by projecting the articulated model in various poses, encompassing all possible poses of the subject. As the process for both the front and back are identical, only one will be described in detail. In creating the database of model poses, the main joint articulations, right and left shoulder, right and left elbow, right and left hip, right and left knee, are modified over their plausible range in the sagittal plane in increments of 5 or 10 degrees. This produces a universe of models in a wide range of expected or possible poses. As noted above, this is repeated for the front and the back, thus creating two databases of images.

These two databases are combined into two data matrices encompassing all of these images. The base articulated model of the subject is projected onto an imaging plane such that the entire model is contained within a 101×101 pixel image, and the depth of the model coded in the intensity of the image. The power in the images are normalized to one, and each of these images are then vectorized, producing a single vector of data of 10,201 elements. This process is repeated for each of the (perhaps) 5000 pose images, producing an image database of 10,201×5000 pixels. The average image vector is calculated and subtracted from all of the image vectors. This results in the complete image reference database. In summary, when creating the image reference database, which is run one time before being used in the initialization portion of the algorithm, the base articulated model of a subject is run through the various poses described above, which produce approximately 5000 versions of the model in different poses, and then each of those 5000 models are projected onto two image planes (front and back) to produce the pose image reference database.

The two data matrices are then decomposed into a Principal Component sub-space using the Singular Value Decomposition algorithm, creating a sub-space that adequately represents the images (and corresponding poses). The first K eigenvectors are chosen to represent the data matrix (in this case, 50). These K eigenvectors are then multiplied against each image vector to produce a point in K-Dimensional space that represents that image, with 5,000 of these K-dimensional points being stored for comparison.

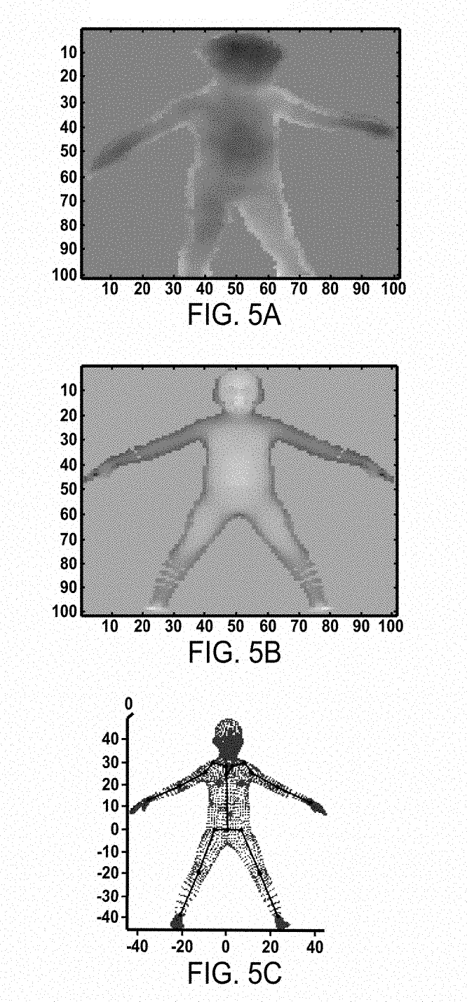

Once a new data set is to be initialized, it is decomposed to its principal component sub-space representation. The point cloud under consideration, after segmentation, is projected onto the same size imaging plane as above, and again is power-normalized (see FIG. 5A). The mean image vector previously calculated is then subtracted from this normalized vector. This vector is then multiplied against the reduced set of database image vectors to produce a new K-dimensional point.

The new sub-space representation is compared to the existing sub-space database of images/poses and the closest fit is taken as the initial estimate of the subject pose (see FIG. 5B). The single K-dimensional point, representing the new point cloud, is then compared to the 5,000 K-dimensional points previously calculated. The closest point is taken as a match, and the pose that produced that image in the database is taken as the initial pose of the articulated model (see FIG. 5C). This process is shown in FIGS. 5A, 5B and 5C.

Referring back to FIG. 4, once the rough size and pose of this point cloud are known, at 408 an adaptation of the Iterated Closest Point algorithm for articulated models is used to change the size and pose of the model to best match the surface of the animator's model. In the traditional Iterated Closest point (ICP) algorithm, two rigid objects, one the reference, which is kept fixed, and the source, which is the object to be transformed, are aligned. The iterative process follows these steps: for each point in the Source point cloud, find the closest point in the Reference point cloud; estimate the rigid transformation that best aligns each Source point to its corresponding Reference point; transform the Source points; and iterate until the alignment stops improving.

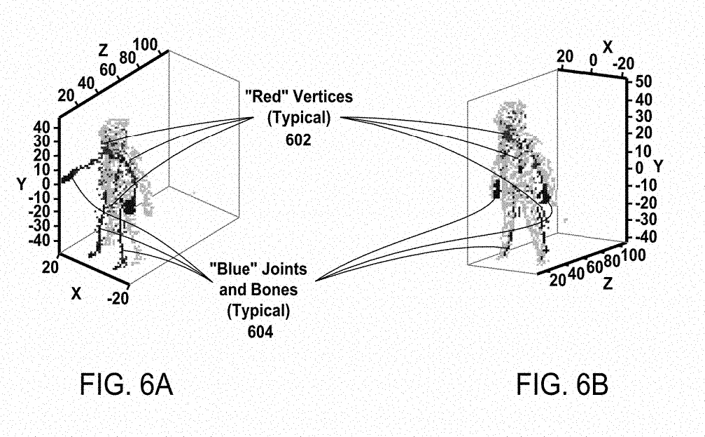

Because in the disclosed embodiments the Source object is not rigid, but is rather an articulated model with many degrees of freedom, a modified ICP algorithm is used. The modified ICP algorithm (see FIGS. 6A and 6B) used here is then: (1) for each point in the articulated model, find the closest point in the 3D point cloud; (2) using optimization techniques on a limited number of parameters, find the joint rotations and/or scalings that best align each model point to its corresponding 3D point cloud point; (3) apply the calculated parameters to the joints and calculate new vertex locations using the skinned-weight mesh model described previously; (4) repeat steps 2 and 3 for all joint parameters of interest; and (5) iterate until the alignment stops improving.

Step (1) of the modified ICP algorithm uses the k-nearest neighbor search technique to find the nearest model points to each cloud point. For step (2), a nonlinear programming multivariable derivative free method is used that minimizes the sum of the distances between the model and corresponding point cloud points. Step (3) of the modified ICP algorithm uses the skinned-weight mesh algorithm previously described. For step (4) of the modified ICP algorithm, the first set of parameters are the overall model position and orientation, followed by overall model size, followed by upper arm orientation, upper leg orientation, lower arm orientation, lower leg orientation, torso size, arm size, leg size.

On termination of the modified ICP algorithm, at 410 the fit between the model and the point cloud is evaluated. If the standard deviation of the distances between the model points and the point cloud points is too high (as some multiple of the mean distance), it is an indication that some part of the model did not fit well and this individual point cloud is then rejected. Otherwise, the point cloud is stored 412.

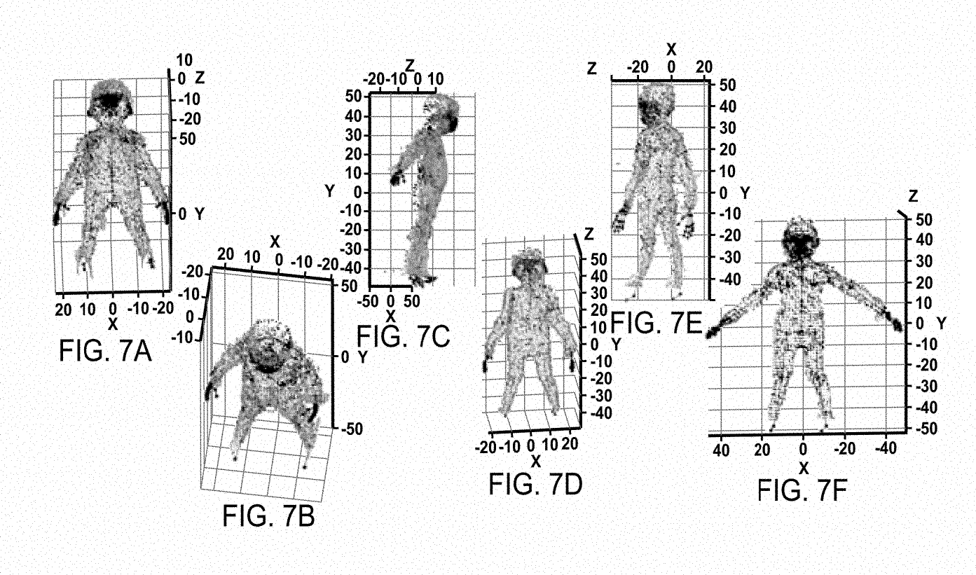

The above procedure is repeated for all of the point clouds individually until there is a set of N point clouds and a corresponding set of N animator's models that minimize the distance between the n^{th} point cloud data set and the n^{th} articulated model vertices for all N point clouds. The mean size of these N models is calculated at 414, and all of the models are adjusted to match this mean size. The anthropometric estimation software will now work on all of the data sets and models as a group, optimizing to find one set of size parameters and N sets of pose parameters that match the animator's models to the 3-D point clouds. This is done by another extension of the ICP cloud algorithm (see FIGS. 7A-7F, which shows six articulated models fitted to six 3-D point clouds), first adjusting the size parameters 416 to match all of the models to their corresponding data sets, then adjusting the pose parameters 418 to match the individual models to the individual point clouds. The algorithm, for all of the point clouds is: (1) or each point in each articulated model, find the closest point in the corresponding 3D point cloud; (2) using optimization techniques on a limited number of parameters, and holding all joint rotations as fixed, find the joint scalings that best align each model point to its corresponding 3-D point cloud point; (3) apply the calculated parameters to the joints and calculate new vertex locations using the skinned-weight mesh model described previously.

For each individual point cloud, (1) or each point in the articulated model, find the closest point in the corresponding 3-D point cloud; (2) using optimization techniques on a limited number of parameters, and holding all joint scalings as fixed, find the joint rotations that best align each model point to its corresponding 3D point cloud point; (3) apply the calculated parameters to the joints and calculate new vertex locations using the skinned-weight mesh model described previously; and (4) iterate until the alignment stops improving.

Once the models converge to the 3-D point clouds as well as they can, the fitting algorithm terminates, leaving multiple articulated models in various poses but of one size.

All of the articulated models at 420 can be moved back to their initial, neutral pose—that is, all of the articulated models can be automatically moved such that their joint rotations are brought back to zero. Knowing the fitted and neutral pose for each of these models, a transformation can be calculated from a model point on the posed model to the same point on the neutral pose model. Knowing that transformation, and knowing which 3D cloud points correspond to which posed model points, allows the appropriate transformation to be applied to each of the 3-D point cloud points. This in turn produces a set of point clouds that are all in a single coordinate system.

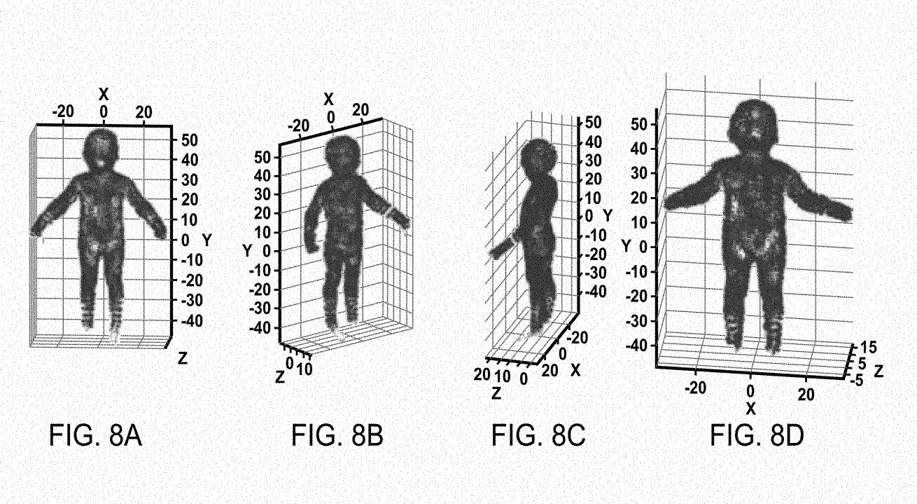

Performing this set of transformations on all of the individual point clouds produces a single merged point cloud 422 in the neutral pose space (see FIGS. 8A-8D, which shows four perspective views of the posture neutral combined point cloud). At 424, an exhaustive fit can be performed to match the neutral model's size to the combined point cloud, again using the modified ICP algorithm and holding all joint rotations constant. This is the final estimate of the articulated model combining all of the information from all of the scans captured on this subject.

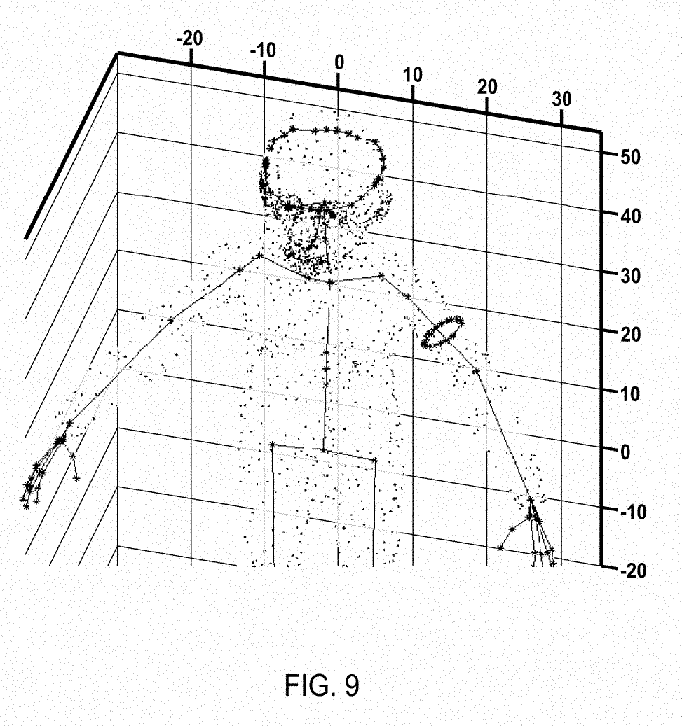

At this point 426, any anthropometric measure of interest can be extracted by measuring distance along defined arcs on the model (see FIG. 9). For example, on a one-time basis prior to any software running, the model can be inspected and a determination of which points describe a circumference about the head can be made. The indices of those points do not change as the model is posed and sized, so once the model has been fit to the combined point cloud, the distances between those points can be summed to determine the head circumference, or any other anthropometric measure of interest.

The fitted model and the anthropometric measures of interest are stored in the cloud database, and the metrics of interest are transmitted back to the data acquisition device via a network connection.

When the logical operations described herein are implemented in software, the process may execute on any type of computing architecture or platform. For example, referring to FIG. 10, an example computing device upon which embodiments of the invention may be implemented is illustrated. In particular, at least one processing device described above may be a computing device, such as computing device 1000 shown in FIG. 10. For example, computing device 1000 may be a component of the cloud computing and storage system 106 described in reference to FIG. 1, computing device 1000 may comprise all or a portion of server 108, or computing device 1000 may comprise all or a portion of acquisition device 102. The computing device 1000 may include a bus or other communication mechanism for communicating information among various components of the computing device 1000. In its most basic configuration, computing device 1000 typically includes at least one processing unit 1006 and system memory 1004. Depending on the exact configuration and type of computing device, system memory 1004 may be volatile (such as random access memory (RAM)), non-volatile (such as read-only memory (ROM), flash memory, etc.), or some combination of the two. This most basic configuration is illustrated in FIG. 10 by dashed line 1002. The processing unit 1006 may be a standard programmable processor that performs arithmetic and logic operations necessary for operation of the computing device 1000.

Computing device 1000 may have additional features/functionality. For example, computing device 1000 may include additional storage such as removable storage 1008 and non-removable storage 1010 including, but not limited to, magnetic or optical disks or tapes. Computing device 1000 may also contain network connection(s) 1016 that allow the device to communicate with other devices. Computing device 1000 may also have input device(s) 1014 such as a keyboard, mouse, touch screen, etc. Output device(s) 1012 such as a display, speakers, printer, etc. may also be included. The additional devices may be connected to the bus in order to facilitate communication of data among the components of the computing device 1000. All these devices are well known in the art and need not be discussed at length here.

The processing unit 1006 may be configured to execute program code encoded in tangible, computer-readable media. Computer-readable media refers to any media that is capable of providing data that causes the computing device 1000 (i.e., a machine) to operate in a particular fashion. Various computer-readable media may be utilized to provide instructions to the processing unit 1006 for execution. Common forms of computer-readable media include, for example, magnetic media, optical media, physical media, memory chips or cartridges, a carrier wave, or any other medium from which a computer can read. Example computer-readable media may include, but is not limited to, volatile media, non-volatile media and transmission media. Volatile and non-volatile media may be implemented in any method or technology for storage of information such as computer readable instructions, data structures, program modules or other data and common forms are discussed in detail below. Transmission media may include coaxial cables, copper wires and/or fiber optic cables, as well as acoustic or light waves, such as those generated during radio-wave and infra-red data communication. Example tangible, computer-readable recording media include, but are not limited to, an integrated circuit (e.g., field-programmable gate array or application-specific IC), a hard disk, an optical disk, a magneto-optical disk, a floppy disk, a magnetic tape, a holographic storage medium, a solid-state device, RAM, ROM, electrically erasable program read-only memory (EEPROM), flash memory or other memory technology, CD-ROM, digital versatile disks (DVD) or other optical storage, magnetic cassettes, magnetic tape, magnetic disk storage or other magnetic storage devices.

In an example implementation, the processing unit 1006 may execute program code stored in the system memory 1004. For example, the bus may carry data to the system memory 1004, from which the processing unit 1006 receives and executes instructions. The data received by the system memory 1004 may optionally be stored on the removable storage 1008 or the non-removable storage 1010 before or after execution by the processing unit 1006.

Computing device 1000 typically includes a variety of computer-readable media. Computer-readable media can be any available media that can be accessed by device 1000 and includes both volatile and non-volatile media, removable and non-removable media. Computer storage media include volatile and non-volatile, and removable and non-removable media implemented in any method or technology for storage of information such as computer readable instructions, data structures, program modules or other data. System memory 1004, removable storage 1008, and non-removable storage 1010 are all examples of computer storage media. Computer storage media include, but are not limited to, RAM, ROM, electrically erasable program read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 1000. Any such computer storage media may be part of computing device 1000.

It should be understood that the various techniques described herein may be implemented in connection with hardware or software or, where appropriate, with a combination thereof. Thus, the methods and apparatuses of the presently disclosed subject matter, or certain aspects or portions thereof, may take the form of program code (i.e., instructions) embodied in tangible media, such as floppy diskettes, CD-ROMs, hard drives, or any other machine-readable storage medium wherein, when the program code is loaded into and executed by a machine, such as a computing device, the machine becomes an apparatus for practicing the presently disclosed subject matter. In the case of program code execution on programmable computers, the computing device generally includes a processor, a storage medium readable by the processor (including volatile and non-volatile memory and/or storage elements), at least one input device, and at least one output device. One or more programs may implement or utilize the processes described in connection with the presently disclosed subject matter, e.g., through the use of an application programming interface (API), reusable controls, or the like. Such programs may be implemented in a high level procedural or object-oriented programming language to communicate with a computer system. However, the program(s) can be implemented in assembly or machine language, if desired. In any case, the language may be a compiled or interpreted language and it may be combined with hardware implementations.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A computer-implemented method of determining anthropometric measurements of a non-stationary subject comprising:
scanning a non-stationary subject using a three-dimensional (3-D) scanner to create a plurality (N) of point clouds of data corresponding to the subject;
using a processor, and for each of the plurality of point clouds:
a. estimating a rough size of the subject using the point cloud of data;
b. estimating a rough pose of the subject using the point cloud of data;
c. changing the estimated rough size and the estimated rough pose of the point cloud of data of the subject to best match a surface of a skinning weight articulated model; and
d. repeating a.-c., above, for each of the plurality (N) of point clouds to create N skinning weight articulated models, wherein each skinning weight articulated model corresponds to one of the plurality of point clouds;
optimizing the N skinning weight articulated models to find one set of size parameters and N sets of fitted pose parameters that minimize the distance between the n^{th} point cloud data set and the n^{th} articulated model vertices for all N point clouds;
moving each of the N skinning weight articulated models to a neutral position from its fitted position, wherein the fitted position is based on the skinning weight articulated model's fitted pose parameters;
determining a transformation based on knowing the fitted and neutral position of each of the N skinning weight articulated models;
applying the transformation to each of the plurality (N) of point clouds to produce a single merged point cloud in the neutral pose space;
matching the merged point cloud in the neutral pose space to a final skinning weight articulated model in the neutral pose; and
obtaining anthropometric measurements from the final skinning weight articulated model in the neutral pose.

2. (canceled)

3. The method of claim 1, wherein scanning the subject using the three-dimensional (3-D) scanner to create a plurality (N) of point clouds of data corresponding to the subject comprises capturing bursts of data from the 3-D scanner.

4. (canceled)

5. (canceled)

6. (canceled)

7. (canceled)

8. (canceled)

9. (canceled)

10. (canceled)

11. The method of claim 1, wherein estimating the rough size of the subject using the point cloud of data comprises estimating the rough size of the subject based on an age of the subject.

12. (canceled)

13. (canceled)

14. The method of claim 1, wherein estimating the rough pose of the subject using the point cloud of data comprises a search through a generated database of possible poses.

15. (canceled)

16. The method of claim 1, wherein changing the estimated rough size and the estimated rough pose of the point cloud of data of the subject to best match the surface of the skinning weight articulated model comprises using an adaptation of an iterated closest point algorithm for articulated models.

17. The method of claim 16, wherein the skinning weight articulated model comprises a computer-generated hierarchical set of bones and joints to form a skeleton created by an animator and a computer-generated skin surface is attached to the skeleton by a weighting technique.

18. The method of claim 1, wherein optimizing the N skinning weight articulated models to find one set of size parameters and N sets of fitted pose parameters comprises:
using a modified iterated closest point cloud algorithm, determining the one set of size parameters by adjusting a size parameter of each of the skinning weight articulated models to match all of the skinning weight articulated models to their corresponding point cloud data; and
determining the N sets of fitted pose parameters by adjusting a pose parameter for each of the skinning weight articulated models to match the skinning weight articulated model to its corresponding point cloud.

19. The method of claim 1, wherein obtaining anthropometric measurements from the final skinning weight articulated model in the neutral pose comprises measuring a distance along defined arcs on the final skinning weight articulated model.

20. (canceled)

21. (canceled)

22. (canceled)

23. A system for determining anthropometric measurements of a non-stationary subject comprising:
an acquisition device;
a three-dimensional (3-D) scanner in communication with the acquisition device, wherein the 3-D scanner in communication with the acquisition device is used to scan a non-stationary subject to create a plurality (N) of point clouds of data corresponding to the subject;
a memory, wherein the memory stores computer-executable instructions; and
a processor in communication with the memory, wherein the computer-executable instructions cause the processor, for each of the N plurality of point clouds:
a. estimate a rough size of the subject using the point cloud of data;
b. estimate a rough pose of the subject using the point cloud of data;
c. change the estimated rough size and the estimated rough pose of the point cloud of data of the subject to best match a surface of a skinning weight articulated model; and
d. repeat a.-c., above, for each of the plurality (N) of point clouds to create N skinning weight articulated models, wherein each skinning weight articulated model corresponds to one of the plurality of point clouds;
e. optimize the N skinning weight articulated models to find one set of size parameters and N sets of fitted pose parameters that minimize the distance between the n^{th} point cloud data set and the n^{th} articulated model vertices for all N point clouds;
f. move each of the N skinning weight articulated models to a neutral position from its fitted position, wherein the fitted position is based on the skinning weight articulated model's fitted pose parameters;
g. determine a transformation based on knowing the fitted and neutral position of each of the N skinning weight articulated models;
h. apply the transformation to each of the plurality (N) of point clouds to produce a single merged point cloud in the neutral pose space;
i. match the merged point cloud in the neutral pose space to a final skinning weight articulated model in the neutral pose; and
j. obtain anthropometric measurements from the final skinning weight articulated model in the neutral pose.

24. (canceled)

25. The system of claim 23, wherein scanning the subject using the three-dimensional (3-D) scanner to create a plurality (N) of point clouds of data corresponding to the subject comprises capturing bursts of data from the 3-D scanner.

26. (canceled)

27. (canceled)

28. (canceled)

29. (canceled)

30. (canceled)

31. (canceled)

32. (canceled)

33. The system of claim 23, wherein the processor executing computer-executable instructions to estimate the rough size of the subject using the point cloud of data comprises the processor executing computer-executable instructions to estimate the rough size of the subject based on an age of the subject.

34. (canceled)

35. (canceled)

36. The system of claim 23, wherein the processor executing computer-executable instructions to estimate the rough pose of the subject using the point cloud of data comprises he processor executing computer-executable instructions to perform a search through a generated database of possible poses.

37. The system of claim 36, wherein the processor executing computer-executable instructions to perform the search through a generated database of possible poses is performed the processor using computer-executable instructions that comprise a sub-space search technique that uses principal component analysis.

38. The system of claim 23, wherein the processor executing computer-executable instructions to change the estimated rough size and the estimated rough pose of the point cloud of data of the subject to best match the surface of the skinning weight articulated model comprises the processor executing computer-executable instructions to use an adaptation of an iterated closest point algorithm for articulated models.

39. The system of claim 38, wherein the skinning weight articulated model comprises a computer-generated hierarchical set of bones and joints to form a skeleton created by an animator and a computer-generated skin surface is attached to the skeleton by a weighting technique.

40. The system of claim 23, wherein the processor executing computer-executable instructions to optimize the N skinning weight articulated models to find one set of size parameters and N sets of fitted pose parameters comprises the processor executing computer-executable instructions to:
use a modified iterated closest point cloud algorithm, determining the one set of size parameters by adjusting a size parameter of each of the skinning weight articulated models to match all of the skinning weight articulated models to their corresponding point cloud data; and
determine the N sets of fitted pose parameters by adjusting a pose parameter for each of the skinning weight articulated models to match the skinning weight articulated model to its corresponding point cloud.

41. The system of claim 23, wherein the processor executing computer-executable instructions to obtain anthropometric measurements from the final skinning weight articulated model in the neutral pose comprises measuring a distance along defined arcs on the final skinning weight articulated model.

42. (canceled)

43. (canceled)

44. (canceled)

45. A non-transitory computer-readable medium with computer-executable instructions thereon, said computer-executable instructions perform a method of determining anthropometric measurements of a non-stationary subject when executed by a processor, said method comprising the steps of:
receiving a plurality (N) of point clouds of data corresponding to anon-stationary subject, wherein the N point clouds have been captured using a three-dimensional (3-D) scanner to create the plurality (N) of point clouds of data corresponding to the subject;
using the processor, and for each of the plurality of point clouds:
e. estimating a rough size of the subject using the point cloud of data;
f. estimating a rough pose of the subject using the point cloud of data;
g. changing the estimated rough size and the estimated rough pose of the point cloud of data of the subject to best match a surface of a skinning weight articulated model; and
h. repeating a.-c., above, for each of the plurality (N) of point clouds to create N skinning weight articulated models, wherein each skinning weight articulated model corresponds to one of the plurality of point clouds;
optimizing the N skinning weight articulated models to find one set of size parameters and N sets of fitted pose parameters that minimize the distance between the n^{th} point cloud data set and the n^{th} articulated model vertices for all N point clouds;
moving each of the N skinning weight articulated models to a neutral position from its fitted position, wherein the fitted position is based on the skinning weight articulated model's fitted pose parameters;
determining a transformation based on knowing the fitted and neutral position of each of the N skinning weight articulated models;
applying the transformation to each of the plurality (N) of point clouds to produce a single merged point cloud in the neutral pose space;
matching the merged point cloud in the neutral pose space to a final skinning weight articulated model in the neutral pose; and
obtaining anthropometric measurements from the final skinning weight articulated model in the neutral pose.

46. (canceled)

47. (canceled)

48. (canceled)

49. (canceled)

50. (canceled)

51. (canceled)

52. (canceled)

53. (canceled)

54. (canceled)

55. (canceled)

56. (canceled)

57. (canceled)

58. (canceled)

59. (canceled)

60. (canceled)

61. (canceled)

62. The method of claim 45, wherein optimizing the N skinning weight articulated models to find one set of size parameters and N sets of fitted pose parameters comprises:
using a modified iterated closest point cloud algorithm, determining the one set of size parameters by adjusting a size parameter of each of the skinning weight articulated models to match all of the skinning weight articulated models to their corresponding point cloud data; and
determining the N sets of fitted pose parameters by adjusting a pose parameter for each of the skinning weight articulated models to match the skinning weight articulated model to its corresponding point cloud.

63. The method of claim 45, wherein obtaining anthropometric measurements from the final skinning weight articulated model in the neutral pose comprises measuring a distance along defined arcs on final skinning weight articulated model.

64. (canceled)

65. (canceled)

66. (canceled)
